(19) United States
(12) Patent Application Publication
(10) Pub. No.: US 2006/0201242 A1
(43) Pub. Date: Sep. 14, 2006

(54) Method of determining airbag deployment tolerance

(75) Inventor: Yoshikazu Nakayama, Tokyo (JP)

Correspondence Address: FOLEY AND LARDNER LLP;SUITE 500, 3000 K STREET NW, WASHINGTON, DC, 20007, US

(73) Assignee: TAKATA CORPORATION

(21) Appl. No.: 11/372,062

(22) Filed: Mar. 10, 2006

Related U.S. Application Data
(60) Provisional application No. 60/661,150, filed on Mar. 14, 2005.

(51) Int. Cl. G01M 7/00; G01L 5/04; G01N 19/00

(52) U.S. Cl. 73/159; 73/12.08; 73/865.9

(57) ABSTRACT

A method is provided for determining a safety factor for an airbag assembly used in the formation of an airbag module. The factor is determined from an initial strength characteristic ascertained from a non-aged piece of airbag fabric and a final strength characteristic ascertained from an artificially aged piece of airbag fabric.

### CROSS-REFERENCE TO RELATED APPLICATIONS

This application claims priority to and the benefit of U.S. Provisional Patent Application Ser. No. 60/661,150, which was filed on Mar. 14, 2005 and which is hereby incorporated by reference in its entirety.

### BACKGROUND

The present invention relates to a method of determining an airbag's deployment tolerance. In particular, the present invention relates to a method for calculating a safety factor (also called a “deployment tolerance”) of a base fabric of an airbag under normal deployment conditions.

Conventionally, it has been known to test an airbag under various deployment conditions, to ensure performance of an airbag module that includes the airbag. For example, airbags are often tested under both static conditions (e.g., the airbag module is mounted on a jig and is deployed by ignition of an inflator) and dynamic conditions (e.g., in simulated automotive accidents that employ crash test dummies).

Static deployment tests are typically performed to ensure full and proper inflation of the airbag and the resultant shape thereof. These static tests involve mounting an airbag module on a jig in a manner that simulates the positioning of the airbag module in a vehicle. These static deployment tests have typically been performed at various temperatures, e.g., a high temperature (85±3° C.) test, a normal temperature (24±3° C.) test, and a low temperature (−35±3° C.) test. Under these conditions, the deployment of the airbag is judged as being acceptable (“OK”) or unacceptable (“no good” or “NG”).

Unfortunately, even though an airbag may be qualified as acceptable under the specific conditions tested, the degree of acceptability is relative unknown. For example, although an airbag may have been acceptable when tested at −35±3° C., it is unknown (or at least not readily known) whether the airbag would also be acceptable at −40° C. The present invention, which has been made in light of this problem, is directed toward a method of determining airbag's deployment tolerance.

### SUMMARY

A safety factor corresponding to a level of degradation of an airbag base fabric in normal deployment may be determined from static deployment tests that use artificially aged pieces of airbag fabric compared to similar non-aged pieces of airbag fabric. This relationship may be determined by using a tensile strength and elongation test, a tear test, or a Mullen burst test to predict the strength of a module assembly.

An embodiment of the present invention addresses a method of determining a safety factor for proper operation of an airbag module. This method includes, among other possible steps: (a) testing an airbag module to ensure proper deployment of an airbag contained in the module; (b) testing a first airbag fabric corresponding to the fabric used to form the airbag to determine an initial strength value; (c) heating a second airbag fabric corresponding to the fabric used in the airbag to a predetermined temperature for a predetermined duration of time in order to simulate aging of the fabric; (d) testing the second airbag fabric to determine a final strength value; and (e) determining a safety factor for proper operation of the airbag module based on the initial and final strength values.

In a further embodiment of this method, the step of determining a safety factor may comprise dividing the initial strength characteristic by the final strength characteristic.

In another further embodiment of this method, the step of testing a first airbag fabric may comprise exposing the first airbag fabric to tensile testing. Similarly, the step of testing the second airbag fabric may comprise exposing the second airbag fabric to the same tensile testing.

In another further embodiment of this method, the step of testing a first airbag fabric may comprise exposing the first airbag fabric to tear testing. Similarly, the step of testing the second airbag fabric may comprise exposing the second airbag fabric to the same tear testing.

In another further embodiment of this method, the step of testing a first airbag fabric may comprise exposing the first airbag fabric to burst testing. Similarly, the step of testing the second airbag fabric may comprise exposing the second airbag fabric to the same burst testing.

Another embodiment of the present invention addresses a method of determining a safety factor for proper operation of an airbag module. This method includes, among other possible steps: (a) testing an airbag module to ensure proper deployment of an airbag contained in the module; (b) testing a first airbag fabric corresponding to the fabric used to form the airbag under a first predetermined condition to determine an initial strength characteristic; (c) artificially aging a second airbag fabric corresponding to the fabric used in the airbag; (d) testing the artificially aged second airbag fabric under the first predetermined condition to determine a final strength characteristic; and (e) determining a safety factor for proper operation of the airbag module based on the initial and final strength values.

In a further embodiment of this method, the step of artificially aging a second airbag fabric may comprise heating the second airbag fabric at a predetermined temperature for a predetermined duration.

In another further embodiment of this method, the step of testing a first airbag fabric may comprise exposing the first airbag fabric to tensile testing. Similarly, the step of testing the artificially aged second airbag fabric may comprise exposing the second airbag fabric to the same tensile testing.

In another further embodiment of this method, the step of testing a first airbag fabric may comprise exposing the first airbag fabric to tear testing. Similarly, the step of testing the artificially aged second airbag fabric may comprise exposing the second airbag fabric to the same tear testing.

In another further embodiment of this method, the step of testing a first airbag fabric may comprise exposing the first airbag fabric to burst testing. Similarly, the step of testing the artificially aged second airbag fabric may comprise exposing the second airbag fabric to the same burst testing.

In another further embodiment of this method, the step of determining a safety factor may comprise dividing the initial strength characteristic by the final strength characteristic.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 shows exemplary test pieces of airbag fabric for tensile testing; and

FIG. 2 shows exemplary test pieces of airbag fabric for tear testing.

### DETAILED DESCRIPTION

Embodiments of the present invention will be described with reference to the drawings. Like numbers are used throughout the drawings to refer to the same or similar parts in each of the embodiments of the invention described herein.

To evaluate the likelihood of performance of an airbag module after being aged, a non-aged airbag module is initially tested (e.g., via a static deployment test) to ascertain whether the airbag module performs satisfactorily. Test pieces of airbag fabric that correspond to the airbag module are then initially tested, e.g., at room temperature, to ascertain an initial strength characteristic. The tests to which the pieces of airbag fabric are subjected may include tensile strength and elongation tests, tear tests, and/or Mullen burst tests.

After the initial tests are complete and the initial strength characteristics determined, similar pieces of airbag fabric are artificially aged. In one embodiment of the present invention, the artificial aging process involves heating the pieces of airbag fabric in a dry heating oven at a particular temperature (e.g., 100° C., 150° C., 200° C., etc.) for a specified amount of time. Each piece of artificially aged airbag fabric is then tested in the same manner as the non-aged pieces of fabric. The test results of artificially aged pieces of fabric, which define a final strength characteristic, are compared with the initial strength characteristic, as later described in detail, to define a safety factor.

Based on the safety factor, the likelihood of proper airbag deployment under a variety of conditions can be readily predicted. As a result, depending on the conditions to which a particular airbag module will likely be exposed, a properly suited airbag assembly may be selected. By way of specific example, if an automobile is to be sold and predictably used in a generally hot climate such as Miami, Fla., an airbag assembly that is suited for such a hot climate may be selected based on a specific safety factor. By way of another example, if an automobile is to be sold and predictably used in a generally cold climate such as Anchorage, AK, a different airbag assembly that is suited for such a frigid climate may be selected based on a different safety factor.

In addition to the foregoing, each piece of fabric may be tested under a plurality of aging conditions, and then compared to the initial strength characteristic. In other words, each piece of airbag fabric may be aged (e.g., baked at 200° C.), e.g., for about 2 hours, 6 hours, 12 hours, 24 hours, 36 hours, 48 hours, 72 hours, etc. Preferably, at least three test pieces of airbag fabric are prepared for each aging condition.

After each simulated aging condition is complete, the pieces of airbag fabric are removed from the oven and allowed to cool, typically for at least four hours. After cooling, the artificially aged pieces of airbag fabric are subjected to the same tests to which the non-aged pieces of airbag fabric were subjected. The results of the tests for the aged pieces of airbag fabric define final strength characteristics.

The initial strength characteristic for each piece of airbag fabric is then compared to the final strength characteristic thereof. For example, the initial strength characteristic may be divided by the final strength characteristic. By way of specific example, when a piece of airbag fabric with an initial fabric strength is degraded by 55.4% (i.e., final strength characteristic is 44.6%) due to being aged, e.g., by being baked for 72 hours at 200° C., a safety factor of the airbag may be defined to be 2.24. Specifically, the safety factor may be calculated as follows:

$$Safety Factor ( e . g . , 2.24 ) = \frac{Initial Strength ( e . g . , 100 \% )}{Final Strength ( e . g . , 44.6 \% )}$$

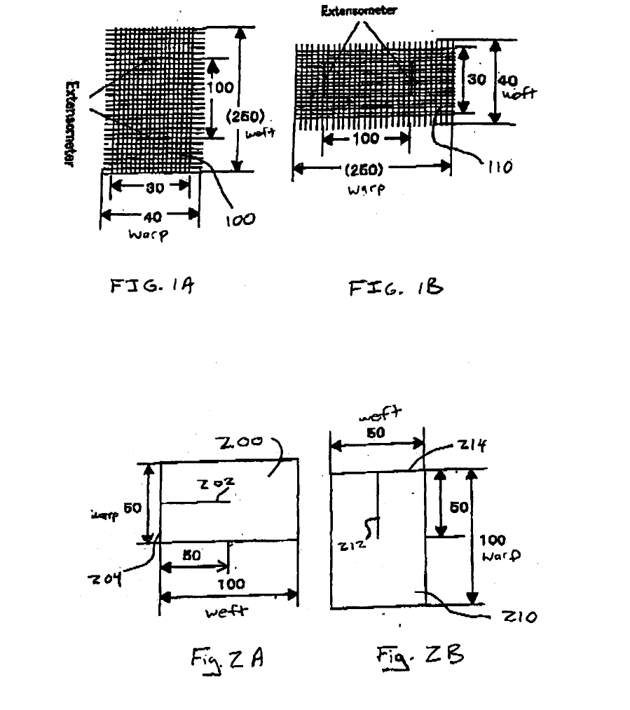

The tensile strength and elongation tests for each new and artificially aged piece of airbag fabric may be performed by using fabric test pieces 100, 110 of a specified size. For example, as shown in FIG. 1A, a fabric test piece 100 may have a size of 250 mm×40 mm (warp×weft yarn direction). Similarly, as shown in FIG. 1B, another fabric test piece 110 may have a size of 40 mm×250 mm (warp×weft yarn direction). In the example shown in FIG. 1A, the test piece 100 has an overall width of 40 mm, which width includes 5 mm of warp yarn on each side, thereby defining a 30 mm effective width. Similarly, in the example shown in FIG. 1B, the test piece 110 has an overall height of 40 mm, which height includes 5 mm of weft yarn on each side, thereby defining a 30 mm effective height.

A specified number (e.g., five) of test pieces may be prepared; some (e.g., two) of the test pieces may be tested under non-aged conditions and the remaining test pieces may be tested after simulated aging, thereby providing a basis for comparison. A conventional fabric material tensile tester (not shown), is then used to test the pieces 100, 110 in the following manner.

Each fabric test piece 100, 110 (non-aged and aged) is installed in clamp portions of the tester with, e.g., 150 mm separating the clamps, thereby enabling the tensile load to be applied evenly. An initial load is then applied to the fabric piece 100, 110 to remove unnatural wrinkles in the fabric piece 100, 110. An extensometer is attached to the loaded fabric piece 100, 110 at a central location, e.g., within a 100 mm central location in the weft direction of the fabric piece 100 (FIG. 1A) or within a 100 mm central location in the warp direction of the fabric piece 110 (FIG. 1B). Specific gauge lines may also be used with the extensometer.

A tension is then applied to the fabric piece 100, 110. For example, a tension may be applied with a rate of 200±10 mm/min. For each fabric piece tested, a maximum strength and elongation, which is ascertained when the fabric piece 100, 110 tears, breaks, or otherwise fails (hereinafter collectively “fail”), are recorded. Test pieces that fail within 10 mm of a clamp portion, that fail abnormally, or that fail between the extensometer set may also be noted.

Low, normal, and high temperature tensile tests may be conducted for each of the fabric pieces 100, 110 according to the above protocol. For example, each of the fabric pieces 100, 110 (non-aged and aged) may be tested at various ambient temperatures, e.g., about −35±3° C. (low temperature testing), at about 24±3° C. (normal room temperature testing), and at about 85±3° C. (high temperature testing).

In addition to the foregoing, the rate of testing may also be adjusted. Specifically, whereas the previously mentioned test occurred at 200 mm/min, tests may also be performed at different speeds. By way of specific example, the pieces of fabric 100, 110 (non-aged and aged) may be subjected to high speed tensile tests at speeds of, e.g., about 0.5 m/s, about 1.0 m/s, about 5.0 m/s, and about 10.0 m/s (i.e., about 30,000, 60,000, 300,000, and 600,000 mm/min, respectively). Tensile strength and maximum strength until failure are preferably indicated for both the warp and weft yarn directions using both of the fabric pieces 100, 110 at each aging condition.

For each artificially non-aged and aged condition, the tensile/elongation test results may be averaged or normalized (e.g., taking into account differences specifically attributable to the weft and warp yarn directions), thereby defining more precisely initial and final strength characteristics. Abnormal test results may be noted and, in some cases, not used in averaging or normalizing the strength characteristics. The final tensile strength characteristic, which may be the result of a normalization/average, may then be compared, in the manner previously discussed, to the initial tensile strength characteristic, which may also be the result of a normalization/average. The result of this comparison defines a safety factor for each of the test pieces 100, 110.

In determining the initial and final strength characteristics using tensile and elongation tests, tensile elongation data may be indicated for each warp and weft yarn direction from the following strain formula:

$$Elongation = \frac{{L}_{2} - {L}_{1}}{{L}_{1}}$$

where L₁ is the gauge length at initial load (e.g., 150 mm) and L₂ is the gauge length at maximum load (i.e., at failure) (e.g., 175 mm). Although the units for tensile strength may be N/cm, elongation lacks units. Conventionally, elongation is, therefore, measured as a percentage, as follows:

$$Elongation \text{:} 16.67 \% = \frac{175 mm - 150 mm}{150 mm} \times 100 \%$$

Tear tests of fabric test pieces may also be conducted using pieces of a specified size. For example, as shown in FIG. 2A, a fabric piece 200 may be cut to have a size of 50 mm×100 mm (warp×weft yarn direction). Similarly, as shown in FIG. 2B, a similar fabric piece 210 may be cut to have a size of 100 mm×50 (warp×weft yarn direction). Each of the test pieces 200, 210 is prepared by cutting a long slit 202, 212 toward the center of the piece 200, 210 at a generally right angle to a short side edge 204, 214 of the piece 200, 210.

Each of the tear test pieces 200, 210 (non-aged and aged) is then set between the clamps of a conventional tensile tester so that the piece 200, 210 is aligned in a direction such that it may tear due to the cut slit 202, 212, i.e., the slit is oriented normal to an imaginary line that extends between the clamps. The test piece 200, 210 is then pulled (e.g., at 200±10 mm/min) and the load at the time of tearing is recorded. High and low temperature tests may also be k conducted in the manner previously discussed, i.e., the tearing tests may also be performed at about −35×3° C. (low temperature testing), at about 24±3° C. (normal room temperature testing), and at about 85±3° C. (high temperature testing).

For each non-aged and aged condition, multiple tear tests pieces 200, 210 are preferably tested. The results of these tear test may be normalized/averaged to define the initial and final strength characteristics. Abnormal test results may be noted and, in some cases, not used to ascertain the strength characteristics.

The final tear strength characteristic, which may be the result of a normalization/average, may then be compared, in the manner previously discussed, to the initial tear strength characteristic, which may also be the result of a normalization/average. The result of this comparison defines a safety factor for the test pieces 200, 210.

Mullen burst tests may also performed on non-aged and aged test pieces of airbag fabric. Specifically, a fabric test piece, such as those shown in FIGS. 1A, 1B, is clamped between two flat, horizontal circular plates in a conventional Mullen burst tester. Fluid is displaced from a chamber by a piston that moves with a constant rate, thereby inflating a diaphragm that expands through an opening in the lower plate and against an area of the test piece that is not supported by the clamping plates. A gauge, which is connected to the cylinder, measures the pressure rise in the cylinder. When the test piece bursts, the maximum pressure in the cylinder is indicated, thereby showing the burst strength of the test piece, which may be defined as a strength characteristic.

For each non-aged and aged condition, multiple burst tests pieces are preferably tested. The results of these burst tests may be normalized/averaged to define the initial and final strength characteristics. Abnormal test results may be noted and, in some cases, not used to ascertain the strength characteristics. The final burst strength characteristic, which may be the result of a normalization/average, may then be compared, in the manner previously discussed, to the initial burst strength characteristic, which may also be the result of a normalization/average. The result of this comparison defines a safety factor for the test pieces.

As a result of the calculated safety factor for a particular airbag assembly based on the initial and final strength characteristics of the airbag fabric, how the airbag assembly will perform under certain long term environmental conditions (e.g., prolonged exposure to high or low temperatures) can be predicted. In light of this predictable performance, a particular airbag assembly may be chosen in a manner that is reflective of, and responsive to, the environment in which the airbag assembly is expected to be used, thereby enhancing the likelihood that the airbag assembly will perform, when needed, in the intended manner.

Given the disclosure of the present invention, one versed in the art would appreciate that there may be other embodiments and modifications within the scope and spirit of the invention. Accordingly, all modifications attainable by one versed in the art from the present disclosure that are within the scope and spirit of the present invention are to be included as further embodiments of the present invention. The scope of the present invention is to be defined as set forth in the following claims.

What is claimed is:

1. A method of determining a safety factor for proper operation of an airbag module, the method comprising the steps of:
testing an airbag module to ensure proper deployment of an airbag contained in the module;
testing a first airbag fabric corresponding to the fabric used to form the airbag to determine an initial strength value;
heating a second airbag fabric corresponding to the fabric used in the airbag to a predetermined temperature for a predetermined duration of time in order to simulate aging of the fabric;
testing the second airbag fabric to determine a final strength value; and
determining a safety factor for proper operation of the airbag module based on the initial and final strength values.

2. The method according to claim 1, wherein the step of determining a safety factor comprises dividing the initial strength characteristic by the final strength characteristic.

3. The method according to claim 1, wherein the step of testing a first airbag fabric comprises exposing the first airbag fabric to tensile testing.

4. The method according to claim 3, wherein the step of testing the second airbag fabric comprises exposing the second airbag fabric to the same tensile testing.

5. The method according to claim 1, wherein the step of testing a first airbag fabric comprises exposing the first airbag fabric to tear testing.

6. The method according to claim 5, wherein the step of testing the second airbag fabric comprises exposing the second airbag fabric to the same tear testing.

7. The method according to claim 1, wherein the step of testing a first airbag fabric comprises exposing the first airbag fabric to burst testing.

8. The method according to claim 7, wherein the step of testing the second airbag fabric comprises exposing the second airbag fabric to the same burst testing.

9. A method of determining a safety factor for proper operation of an airbag module, the method comprising the steps of:
testing an airbag module to ensure proper deployment of an airbag contained in the module;
testing a first airbag fabric corresponding to the fabric used to form the airbag under a first predetermined condition to determine an initial strength characteristic;
artificially aging a second airbag fabric corresponding to the fabric used in the airbag;
testing the artificially aged second airbag fabric under the first predetermined condition to determine a final strength characteristic; and
determining a safety factor for proper operation of the airbag module based on the initial and final strength values.

10. The method according to claim 9, wherein the step of artificially aging a second airbag fabric comprises heating the second airbag fabric at a predetermined temperature for a predetermined duration.

11. The method according to claim 9, wherein the step of testing a first airbag fabric comprises exposing the first airbag fabric to tensile testing.

12. The method according to claim 11, wherein the step of testing the artificially aged second airbag fabric comprises exposing the second airbag fabric to the same tensile testing.

13. The method according to claim 9, wherein the step of testing a first airbag fabric comprises exposing the first airbag fabric to tear testing.

14. The method according to claim 13, wherein the step of testing the artificially aged second airbag fabric comprises exposing the second airbag fabric to the same tear testing.

15. The method according to claim 9, wherein the step of testing a first airbag fabric comprises exposing the first airbag fabric to burst testing.

16. The method according to claim 15, wherein the step of testing the artificially aged second airbag fabric comprises exposing the second airbag fabric to the same burst testing.

17. The method according to claim 9, wherein the step of determining a safety factor comprises dividing the initial strength characteristic by the final strength characteristic.
